(19) United States
(12) Patent Application Publication
(10) Pub. No.: US 2009/0308672 A1
(43) Pub. Date: Dec. 17, 2009

(54) Mobile Aircraft Seat-Wheelchair for Disabled Passengers and People Requiring Assistance

(76) Inventor: Thomas Soldatos, Agios Dimitrios Attikis (GR)

Correspondence Address: Thomas Soldatos, 6A Labirinthou Kritis Str, Athens, Agios Dimitrios Attikis, GR-173 42, GR

(21) Appl. No.: 12/085,463

(22) PCT Filed: Nov. 20, 2006
(86) PCT No.: PCT/GR2006/000062

§ 371 Date: May 23, 2008

(30) Foreign Application Priority Data
Nov. 25, 2005 (GR) 20050100585

(51) Int. Cl. A61G 5/04; A61G 5/00; A61G 3/08; A61G 5/10; B65G 67/00

(52) U.S. Cl. 180/65.1; 280/250.1; 414/391

(57) ABSTRACT

The mobile aircraft seat-wheelchair for people requiring special assistance consists of a standard aircraft seat that includes a seat (2), two armrests (1) and a backrest (3), as well as wheels (7) attached on the chassis (11), a legs rest (13), a handle (16), a motor mechanism (6) for its motion, control panels (4,5), a secure locking mechanism (8,9) for its locking on the aircraft cabin floor (15), and inputs (10) for the electrical connection between aircraft systems and access buttons (14) of the aircraft seat-wheelchair The mobile aircraft seat-wheelchair can be used by disabled people and assistants ail the way through, from the car park of a departing airport up to the pick up point of the arrival airport, including intermediate steps like boarding ramps, jet ways, lifts, shuttle uses, ambilifts, and within the aircraft cabin during flight. In the last case, it can be used by able-bodied passengers too, if there is no disabled passenger in the flight.

The invention refers to a multifunctional product that combines a standard aircraft seat with a wheelchair that can be used by disabled, requiring assistance aircraft passengers, as well as able-bodied passengers. This device consists of an aircraft seat, wheels, motor mechanism and secure locking mechanism.

The existing aircraft procedure for embarking and disembarking an aircraft for reduced mobility passengers; include a sequence of various steps using several specifically designed wheelchairs. The procedure involves manually transferring passengers from one wheel chair to the other, before eventually placing them on the fixed aircraft seat on the aircraft. Consequently the current procedure is time consuming, inconvenient and physically straining, for disabled passengers, the ground handling agents and airlines. Moreover there is a high injury risk for both disabled passengers and persons assisting them.

According to the Disabled Persons Transport Advisory Committee (DPTAC) based in the UK, and the Disability Discrimination Act (1995) (of the English law), it is unlawful to treat disabled people less favourably than other people for a reason related to the disability. It is demanded that airports, like other service providers may have to alter the physical features of existing premises and procedures, if the service is impossible or unreasonably difficult for a disabled person to use. The guidelines state that the inconvenient and often frustrating procedure used for the disabled passenger when embarking and disembarking an airplane may have to alter in order that air travel becomes more convenient to this user group.

Previous patents attempted to improve access of disabled passengers to the aircraft. Patent number US2003033671 discloses a wheelchair and a platform device for movement of a disabled person from a wheelchair to a chair seat support in a vehicle and aircraft. U.S. Pat. No. 4,278,387, discloses a device for transferring a handicapped person from a wheel or handicap chair. A pair of tracks is extendable from a motor vehicle. The pair of tracks extend from the motor vehicle, engage the seat on the wheelchair, and then retract into the motor vehicle to move the seat into the motor vehicle. U.S. Pat. No. 4,354,791, discloses a wheelchair construction which includes a seat that is laterally movable on a pair of tracks that engage a similar set of tracks for moving a handicapped person from the wheelchair. The seat has rollers that roll in the tracks. The person is manually moved laterally with the rollers and tracks. U.S. Pat. No. 4,266,305, discloses a seat on a wheelchair that is movable backward to position the seat over a toilet seat. U.S. Pat. No. 4,527,829 refers to a foldable wheel chair, especially designed for invalids, which can be used in an aircraft aisle as well without avoiding the passenger's transfer from the foldable wheelchair to the aircraft seat. Moreover, other patents presented different ways of securing wheelchairs or patient transportation apparatus on vehicles, such as NL 8501237A describing a mechanism to lock wheel chair with occupant in motor vehicle, U.S. Pat. No. 5,026,225 describing a passenger and wheelchair securement system for vehicles, GB 2 364 028 A referring to a wheelchair restraint with occupant safety belt, and GB 2 390 062 A referring to a patient transportation apparatus.

The present invention merges the existing procedures into a single one, as it is an autonomous mobile aircraft seat that can be detached from the aircraft cabin floor. The user or assisting person can operate it giving disabled passengers the ability to circulate within the terminal building and aircraft without the need of using any other supportive equipment, as the user remains seated on the aircraft seat-wheelchair from the departing airport terminal to the destination airport terminal and during flight. This can decrease the number of, and the time spent on disabled passenger transfers making the embarking/disembarking procedure a more dignified service for them, thus reducing the risk of injuries for passengers and personnel as well.

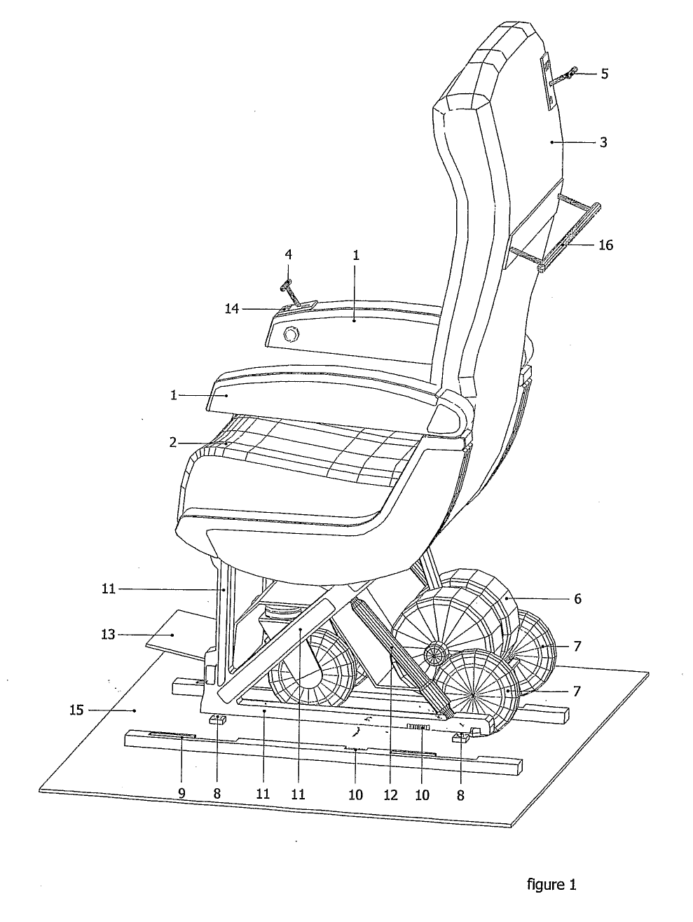

As depicted in FIG. 1, the aircraft seat-wheelchair consists of a standard aircraft seat with motor- or non-powered wheels (7), attached on the main chassis (11), and positioned on the lower part of the device. The aircraft seat of the device is identical to the rest of aircraft seats within the aircraft cabin in terms of design, colours, features and safety requirements, consisting of a seat (2), two armrests (1) and a backrest (3). Moreover, there is a legs rest (13) for the disabled passenger to rest and for the safe operation of the device as well.

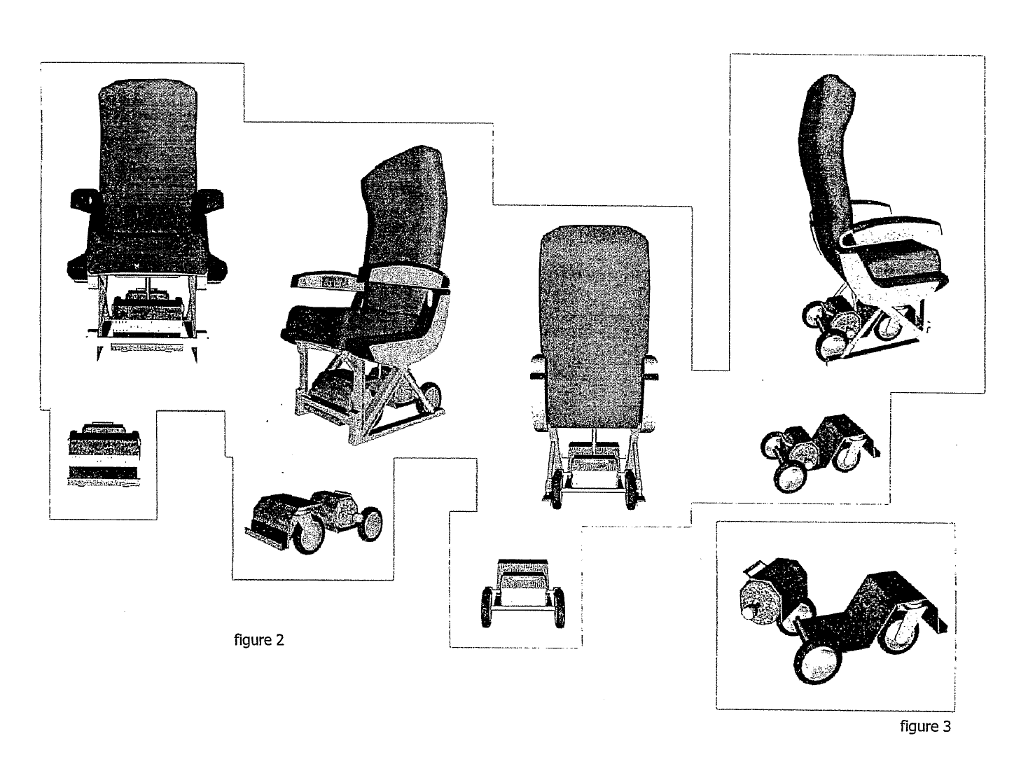

The autonomous motion of the device is insured by a fixed on the seat-wheelchair, or portable mechanism depending on operational requirements, as shown in FIGS. 2 and 3. The mechanism includes electric motors (6), powered by rechargeable batteries. The electric motors' mechanism controls the motion and the direction of the device, operated, either by the user or the assisting person, from two different control panels (4,5) placed on the armrest (1) and the backrest (3) part of the aircraft seat.

The presence of the motor (6) is not necessary for the device to operate, as there could be an option for manual use without any motor as well. In that case, a handle (16) is installed on the backrest (3) of the aircraft seat-wheelchair, for manual operation by the assisting person. On the lower part of the aircraft seat-wheelchair there are inputs (10) that provide electrical connections during flight between aircraft systems and access buttons (14) installed on the aircraft seat-wheelchair providing the passengers entertainment features and cabin crew attention. There are also inputs (10) that ensure the recharging of the batteries for the motor mechanism.

A part of the secure locking mechanism (8) is incorporated in or mounted on the main chassis (11) of the device for the locking of the seat-wheelchair in a pre-allocated space on the cabin floor (15), and more specifically on the complementary part of the locking mechanism (9) of the cabin floor, complying with all standard flight safety requirements.

In the designs of FIGS. 1-3, there has been presented one possible case of application in the form of an already built experience prototype. However, there can exist various types of secure locking mechanisms and motor mechanisms, electric or hydraulic (12), as part of the locking and unlocking procedure of the aircraft seat-wheelchair on the cabin floor.

The mobile aircraft seat-wheelchair will be available for use to the disabled passenger on the arrival in the departing airport, from the car park to the arrival hall or pick up point at the destination airport. The passenger will have the chance to either manoeuvre the aircraft seat-wheelchair on his/her own or with assistance of an escorting person depending on the type of the disability. The user or assisting person will be able to autonomously use the aircraft seat-wheelchair by selecting speed and direction through a function control panel/handset with choices of fast/slow, front, left and right movement transmitting commands to the central/control unit within the motor.

More specifically, the disabled passenger will have the opportunity to use the chair initially with the help of an escorting person at the departing airport or one of the land-side customer service assistants all the way to airside and the departing gates, where he/she can easily have access to the boarding ramps, jet ways, mobile lounges or lifts leading to the aircraft. In the common case that the aircraft is parked in remote places from the terminal building, parking stands, and the use of a shuttle bus is required, the seat-wheelchair user will still have the opportunity to embark using the bus wheelchair ramp to join the rest of the passengers transferred to the aircraft.

On the aircraft, the disabled passenger will be able to enter the aircraft cabin using a wheelchair lifting device similar to the ones that are used for disabled access in buildings. This separate device can possibly be installed to the autonomous hydraulically powered stairs used at present. Until this option is adopted, the embarking and disembarking procedures of the disabled passengers can still be performed following the current practice of the ambilift, an uplifting device for accessing the aircraft.

Entering the aircraft cabin, the passenger will have the ability to manoeuvre on his/her own following the cabin crew or engineer instructions to position and securely engage the wheelchair to the allocated space provided to this particular type of seat. During flight the disabled passengers will have the opportunity to use their own mobile aircraft seat to manoeuvre either on their own or with cabin crew assistance within the aircraft cabin.

On the arrival of the plane at the destination airport similar procedures as described above will be used for the disembarkation of the disabled passengers from the aircraft, all the way through the arrival hall and the exit from the airport premises.

The number of the portable aircraft seat-wheelchairs that will be available on different types of aircraft will depend upon the current needs of disabled air travellers, according to the airlines' statistics concerning the number of disabled passengers in its flight, taking into consideration aircraft safety restrictions. Moreover, to keep low operational costs, a minimum number of portable aircraft seat-wheelchairs can be held as stock for each airline company on all servicing airports, thus minimising the aircraft turnaround time by replacing the empty space. Finally, if there are no disabled passengers onboard, the mobile aircraft seat-wheelchair can be used by able-bodied passengers as a normal fixed aircraft seat, identical in general design features with the rest of the aircraft seats complying with all airline and aircraft safety requirements. The design of the proposed aircraft seat-wheelchair should take into consideration in the future a series of factors and parameters, such as cabin design aspects, seating allocations, emergency restrictions, passengers and personnel health and safety, operating costs and the interests of the aviation and airline industry to provide improved service quality.

1. The mobile aircraft seat-wheelchair for people requiring special assistance is a standard aircraft seat that is characterized by the fact that incorporates in its structure wheels (7) that are attached to, and placed on the lower part of the device, by the fact that it comprises a legs rest (13) for the disabled passenger to rest and for the safe operation of the device, and by the fact that it includes an electric motor mechanism (6), powered by rechargeable batteries, that controls the motion and direction of the device from two different control panels (4,5) positioned on the armrest (1) and the backrest (3) part of the seat, as well as by the fact that a secure locking mechanism (8) is incorporated in or mounted on the main chassis (11) of the device for the locking of the aircraft seat-wheelchair on the cabin floor (15) in a pre-allocated space within the aircraft cabin, and more specifically on the complementary part of the locking mechanism (9) of the cabin floor, and by the fact that there are inputs (10) on the lower part of the device, some of which ensure electrical connections during flight between aircraft systems and access buttons (14) installed on the aircraft seat-wheelchair providing the passengers entertainment features and cabin crew attention, while some other inputs (10) ensure the recharging of the batteries for the motor mechanism.

2. The mobile aircraft seat-wheelchair for people requiring special assistance is, according to claim 1, a standard aircraft seat. The aircraft seat is characterized by the fact that it is identical to the rest of aircraft seats within the aircraft cabin in terms of design, colours, features and safety requirements, and by the fact that it consists of a seat (2), two armrests (1) and a backrest (3).

3. The mobile aircraft seat-wheelchair for people requiring special assistance comprises in its structure, according to claim 1, wheels (7), which are attached to, and placed on the lower part of the device, and that they can be motor powered or non motor powered.

4. The mobile aircraft seat-wheelchair for people requiring special assistance comprises in its structure, according to claim 1, a legs rest (13) for the disabled passenger to rest and for the safe operation of the device.

5. The mobile aircraft seat-wheelchair for people requiring special assistance incorporates in its structure, according to claim 1, an electric motor mechanism (6) powered by rechargeable batteries, that can be fixed on the aircraft seat-wheelchair or be portable and removable depending on operational requirements, and that controls the motion and direction of the device from two different control panels (4,5) placed on the armrest (1) and backrest (3) part of the seat. The presence of the motor (7) is not necessary for the device to operate, as there could be an option for manual use without any motor as well. In that case, a handle (16) is installed on the backrest (3) of the aircraft seat-wheelchair, for manual operation by the assisting person.

6. The mobile aircraft seat-wheelchair for people requiring special assistance has as part of its structure, according to claim 1, a secure locking mechanism (8) that is mounted on the main chassis (11) of the device for the locking of the aircraft seat-wheelchair on the cabin floor (15), complying with all standard flight requirements, in a pre-allocated space within the aircraft cabin, and more specifically on the complementary part of the locking mechanism (9) of the cabin floor.

7. The mobile aircraft seat-wheelchair for people requiring special assistance comprises, according to claim 1, inputs (10) on its lower part, some of which ensure electrical connections during flight between aircraft systems and access buttons (14) installed on the aircraft seat-wheelchair providing the passengers entertainment features and cabin crew attention, while some other inputs (10) ensure the recharging of the batteries for the motor mechanism (6).

8. The mobile aircraft seat-wheelchair for people requiring special assistance comprises in its structure, according to claim 1, a secure locking mechanism (8,9) and motor mechanism (6), which can exist in electric or hydraulic (12) form, as part of the locking and unlocking procedure of the aircraft seat-wheelchair on the cabin floor (15).

9. The mobile aircraft seat-wheelchair will be available for use to the disabled passenger on the arrival in the departing airport, from the car park to the arrival hall or pick up point at the destination airport. The passenger will have the chance to either manoeuvre the aircraft seat-wheelchair on his/her own or with assistance of an escorting person depending on the type of the disability all the way to airside and the departing gates, where he/she can easily have access to the boarding ramps, jet ways, mobile lounges or lifts leading to the aircraft. In the common case that the aircraft is parked in remote places from the terminal building, parking stands, and the use of a shuttle bus is required, the seat-wheelchair user will still have the opportunity to embark using the bus wheelchair ramp to join the rest of the passengers transferred to the aircraft.

10. On the aircraft, the disabled passenger will be able to enter the aircraft cabin using a wheelchair-lifting device similar to the ones that are used for disabled access in buildings. This separate device can possibly be installed to the autonomous hydraulically powered stairs used at present. Until this option is adopted, the embarking and disembarking procedures of the disabled passengers can still be performed following the current practice of the ambilift, an uplifting device for aircraft access.

11. Entering the aircraft cabin the passenger will have the ability to manoeuvre on his/her own following the cabin crew or engineer instructions to position and securely engage the wheelchair to the allocated space provided to this particular type of seat. During flight the disabled passengers will have the opportunity to use their own mobile aircraft seat to manoeuvre either on their own or with cabin crew assistance within the aircraft cabin.

12. On the arrival of the plane at the destination airport similar procedures as described above will be used for the disembarkation of the disabled passengers from the aircraft, all the way through the arrival hall and the exit from the airport premises.

13. The number of the portable aircraft seat-wheelchairs that will be available on different types of aircraft will depend upon the current needs of disabled air travellers, according to the airlines' statistics concerning the number of disabled passengers in its flight, taking into consideration aircraft safety restrictions. Moreover, to keep low operational costs, a minimum number of portable aircraft seat-wheelchairs can be held as stock for each airline company on all servicing airports, thus minimising the aircraft turnaround time by replacing the empty space. Finally, if there are no disabled passengers onboard, the mobile aircraft seat-wheelchair can be used by able-bodied passengers as a normal fixed aircraft seat, identical in general design features with the rest of the aircraft seats complying with all airline and aircraft safety requirements.
